(19) United States
(12) Patent Application Publication
(10) Pub. No.: US 2018/0061263 A1
(43) Pub. Date: Mar. 1, 2018

(54) IMAGE FORMING APPARATUS AND GRADING ASSISTANCE METHOD

(71) Applicant: KYOCERA Document Solutions Inc., Osaka (JP)

(72) Inventor: Masaaki NISHIHARA, Osaka (JP)

(73) Assignee: KYOCERA Document Solutions Inc., Osaka (JP)

(21) Appl. No.: 15/693,049

(22) Filed: Aug. 31, 2017

(30) Foreign Application Priority Data
Aug. 31, 2016 (JP) 2016-169036

(51) Int. Cl. G09B 7/02; G09B 5/02; G06F 17/24; H04N 1/00

(52) U.S. Cl. CPC G09B 7/02; G09B 5/02; H04N 2201/0094; H04N 1/00331; G06F 17/243

(57) ABSTRACT

Provided is an image forming apparatus that effectively supports grading of answer sheets. An answer-processing unit obtains image data of answered answer sheets for all answerers, extracts all answer fields and name fields as image data, correlates and records the image data in a scanning-data DB. A collective-output unit generates, prints and outputs a collected answer collection for which only the same answer field is extracted. A grading-processing unit obtains graded collective-printing output for grading, and extracts and records that output as image data. Moreover, the grading-processing unit determines a score by identifying “Os”, Xs” and the like that are added to the image data. A result-output unit obtains the image data and total score of an answerer for which a specification was received (person that is the object of printing), and prints and outputs a graded answer sheet.

### INCORPORATION BY REFERENCE

This application is based on and claims the benefit of priority from Japanese Patent Application No. 2016-169036 filed on Aug. 31, 2016, the contents of which are hereby incorporated by reference.

### BACKGROUND

The present disclosure relates to an image forming apparatus and a grading assistance method.

There is technology that uses an image forming apparatus such as a multifunction peripheral (MFP) for checking question answer sheets or survey answer sheets that are made using handwriting. In typical technology, the same answers (areas) of plural answer sheets are collectively printed based on format information. As a result, checking by a grader is made easy. Moreover, by scanning again additional information such as “Os”, “Xs” and the like during checking, and replacing images, a checked answer sheet is created.

### SUMMARY

The image forming apparatus according to the present disclosure includes an answer-processing unit, a collective-output unit, a grading-processing unit and a result-output unit. The answer-processing unit obtains an answer sheet on which answers are written as image data, identifies areas of answer fields on the answer sheet, extracts image data of the answer fields, and holds the image data in a specified storage area. The collective-output unit collects and arranges image data of plural answerers that is held in the storage area for an answer field for a same question, and generates and outputs printing data for grading. The grading-processing unit obtains the printing data for grading that has been graded as image data and holds that image data in a specified storage area, extracts information that is added to the graded printing data for grading, and based on the extracted information determines a score for the answer field, and for each answerer, calculates a total score of the scores of the answer fields of all questions included on the answer sheet. The result-output unit collects the graded answer fields for all of the questions and the total score for each answerer, and outputs the answer sheets that were answered by the answerers in a graded state.

The grading-assistance method of the present disclosure is a grading-assistance method that uses an image forming apparatus and includes, an answer-processing step, a collective-output step, a grading-processing step, and a result-output step. The answer-processing step obtains an answer sheet on which answers are written as image data, identifies areas of answer fields on the answer sheet, extracts the image data of the answer fields, and holds the image data in a specified storage area. The collective-output step collects and arranges image data of plural answerers that is held in the storage area for answer fields for the same question, and generates and outputs printing data for grading. The grading-processing step obtains graded printing data for grading as image data, holds that image data in a specified storage area, extracts information that is added to the graded printing data for grading, and based on the extracted information, determines a score for the answer fields, and for each answerer, calculates a total score of the scores of the answer fields of all questions included on the answer sheet. The result-output step collects the graded answer fields for all of the questions and the total score for each answerer, and outputs the answer sheets that were answered by the answerers in a graded state.

### BRIEF DESCRIPTION OF THE DRAWINGS

FIG. 1 is a function block diagram illustrating an overview of the configuration of an image forming apparatus according to an embodiment.

FIG. 2A illustrates an example of an answer sheet according to an embodiment.

FIG. 2B illustrates an example of an answer sheet according to an embodiment.

FIG. 3 is a diagram illustrating an example of a template-scanning answer sheet that is read by a grading-support-processing unit according to an embodiment.

FIG. 4 is a diagram illustrating an example of a collective-printing template according to an embodiment.

FIG. 5A is a diagram illustrating an example of collective-printing output for grading according to an embodiment.

FIG. 5B is a diagram illustrating an example of collective-printing output for grading according to an embodiment.

FIG. 6A is a diagram illustrating an example of collective-printing output for grading for collective grading according to an embodiment.

FIG. 6B is a diagram illustrating an example of collective-printing output for grading for collective grading according to an embodiment.

FIG. 7A is a diagram illustrating a post-grading printing template, and final output results in which the grading results are reflected on the post-grading printing template according to an embodiment.

FIG. 7B is a diagram illustrating a post-grading printing template, and final output results in which the grading results are reflected on the post-grading printing template according to an embodiment.

FIG. 8 is a function block diagram of a grading-support-processing unit according to an embodiment.

FIG. 9 is a block diagram illustrating the functional configuration of a scanning-data DB according to an embodiment

FIG. 10A is a diagram illustrating an example of a table provided in a management DB according to an embodiment.

FIG. 10B is a diagram illustrating an example of a table provided in a management DB according to an embodiment.

FIG. 11 is a flowchart of a grading-support process according to an embodiment.

### DETAILED DESCRIPTION

In the following, forms for embodying the technology according to the present disclosure (hereafter, referred to as embodiments) will be explained with reference to the drawings. The present embodiment proposes technology in which a grading-support function is provided in an image forming apparatus such as a multifunction peripheral (MFP). In the grading-support function, the answer sheets of plural answerers are scanned, and the answer areas (answer fields) of all of the answerers for each problem are collected and printed as collective-printing sheets. The grader grades a collective-printing sheet that has been printed and outputted. When grading, the grader enters “Os”, “Xs” or partial scores (or minus points) on the collective-printing sheet, and scans the collective-printing sheet by the image forming apparatus. The image forming apparatus performs recognition of specific marks “Os”, “Xs” and the like, or partial scores on the collective-printing sheet, and finally, based on the scanning results of the collective-printing sheets for all of the problems, reflects the grading results for each respective answerer on answer sheets and outputs the answer sheets.

There is also a grading-support function that performs grading automatically by giving scoring information for the scores in addition to the “O” and “X” information. In this grading-support function, characters are recognized using OCR when scanning answers, and when performing collective printing, printing is performed after sorting the answers. By employing this kind of technology, similar answers are arranged together, improving the ease of grading. Moreover, grading can be such that answers of plural answerers to the same problem can be collectively checked, thus improving the grading efficiency.

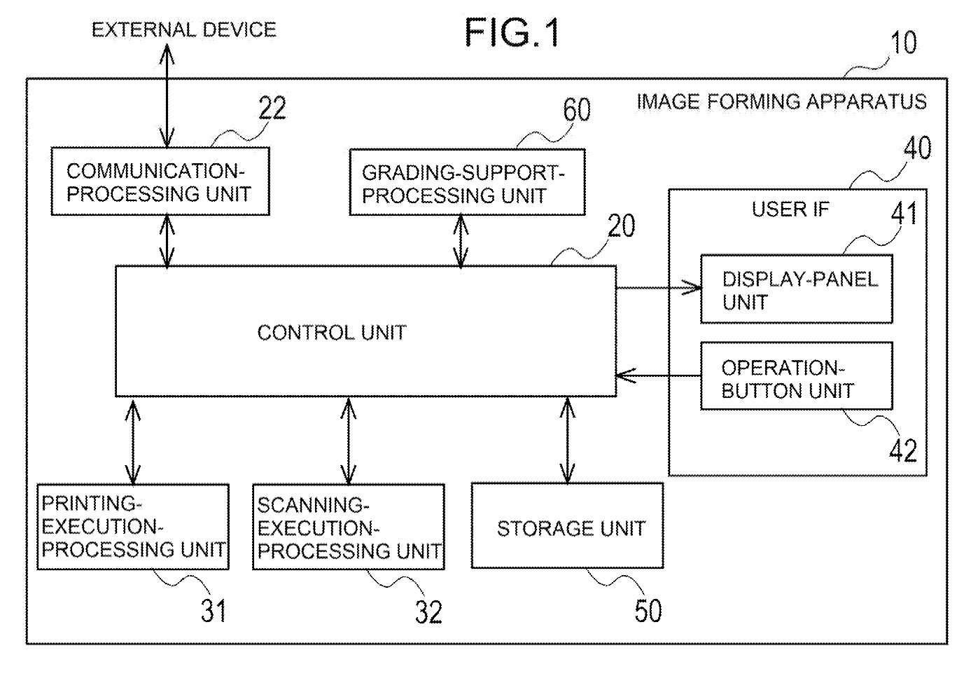

FIG. 1 is a function block diagram illustrating an overview of the configuration of an image forming apparatus 10. The image forming apparatus 10 is a multifunction peripheral (MFP), for example, and includes plural functions such as a printing function, a scanning function, a FAX function and the like.

More specifically, the image forming apparatus 10 includes a control unit 20, a communication-processing unit 22, a printing-execution-processing unit 31, a scanning-execution-processing unit 32, a user IF 40, a storage unit 50, and a grading-support-processing unit 60.

The communication-processing unit 22 is a communication interface such as a wired LAN, wireless LAN, USB communication device and the like, and is connected with a client terminal such as a PC and the like via a network so that communication is possible.

The control unit 20 includes a MPU (Micro-Processing Unit), ROM (Read Only Memory), RAM (Random Access Memory) and the like, and by performing comprehensive control of each of the component elements, a printing-output process, a reading process such as reading a document, a status-monitoring process for monitoring the operation of the component elements, user management, operation control and the like are performed.

The storage unit 50, for example, is an internal storage device such as a large-capacity HDD, SSD or the like, and temporarily stores a printing job before execution by the printing-execution-processing unit 31, or a transmission job before execution by the scanning-execution-processing unit 32. The stored data is maintained for a specified period.

The printing-execution-processing unit 31 has a typical printing-execution function, and executes printing operations according to instructions from the control unit 20. The scanning-execution-processing unit 32 has typical configuration, and includes a scanner, a platen glass, a document-reading slit and the like, and executes a document reading process.

The user IF 40 includes a display-panel unit 41 and an operation-button unit 42. The display-panel unit 41 displays status information, operation information and the like related to the image forming apparatus 10. The operation-button unit 42 receives user operations for the image forming apparatus 10. The operation-button unit 42 may be a touch-panel type IF that is integrally configured with the display-panel unit 41, an IF for physical buttons, or an interface that is a combination of these.

The grading-support-processing unit 60 executes processing of the grading-support process that is a characteristic function in this embodiment by cooperating with other configuration.

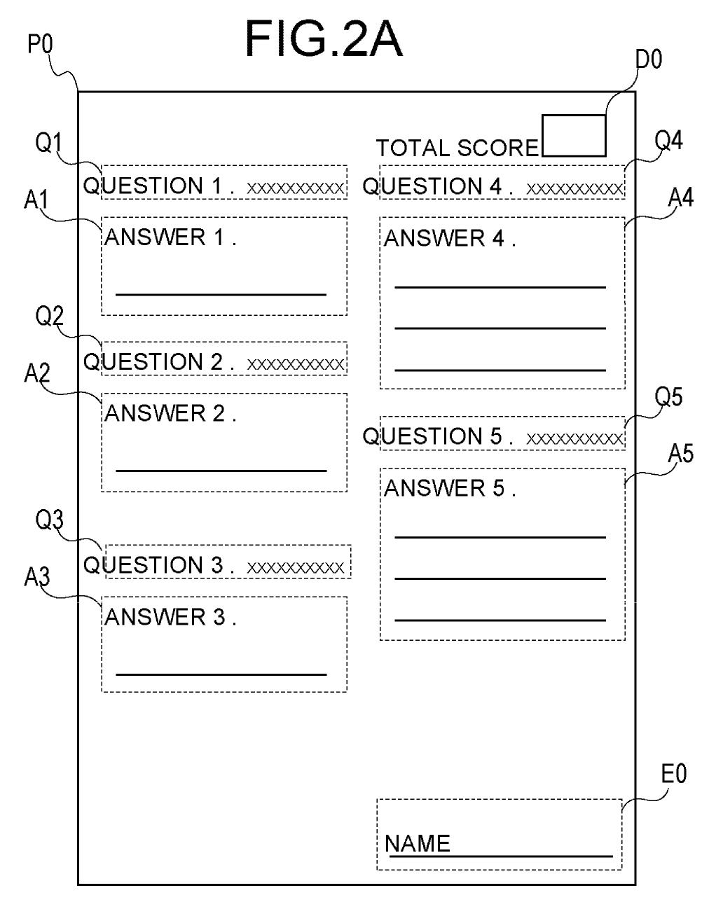

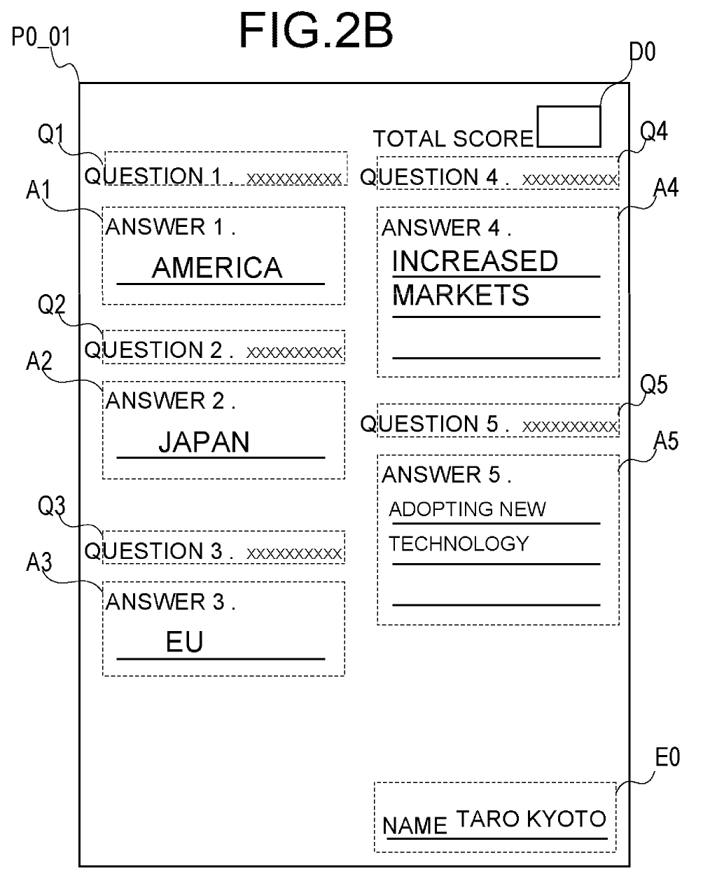

Here, an overview of the grading-support process will be explained with reference to FIG. 2A to FIG. 6B. FIG. 2A and FIG. 2B illustrate examples of answer sheets, where FIG. 2A illustrates an example of an unused answer sheet P0, and FIG. 2B illustrates an example of a completed answer sheet P0_01.

In the unused answer sheet P0, in order from the top on the left side of the sheet a first question area Q1, a first answer area A1, a second question area Q2, a second answer area A2, a third question area Q3, and a third answer area A3 are provided. In order from the top on the right side of the answer sheet there is a grading result field D0, a fourth question area Q4, a fourth answer area A4, a fifth answer area Q5, a fifth answer area A5, and a name-entry area E0.

In the completed answer sheet P0_1, the answerer has entered “Taro Kyoto” in the name-entry area E0 as the answerer's own name. Furthermore, for example, the answerer has entered “America” in the first answer area A1 on the left side of the sheet, and has entered “Adopt new technology” in the fifth answer area A5 on the right side of the sheet. The completed answer sheets P0_01 for all of the answerers for which grading is performed are scanned and recorded as image data. An index such as an ID or the like is added to and recorded for each respective image data in the scanning order.

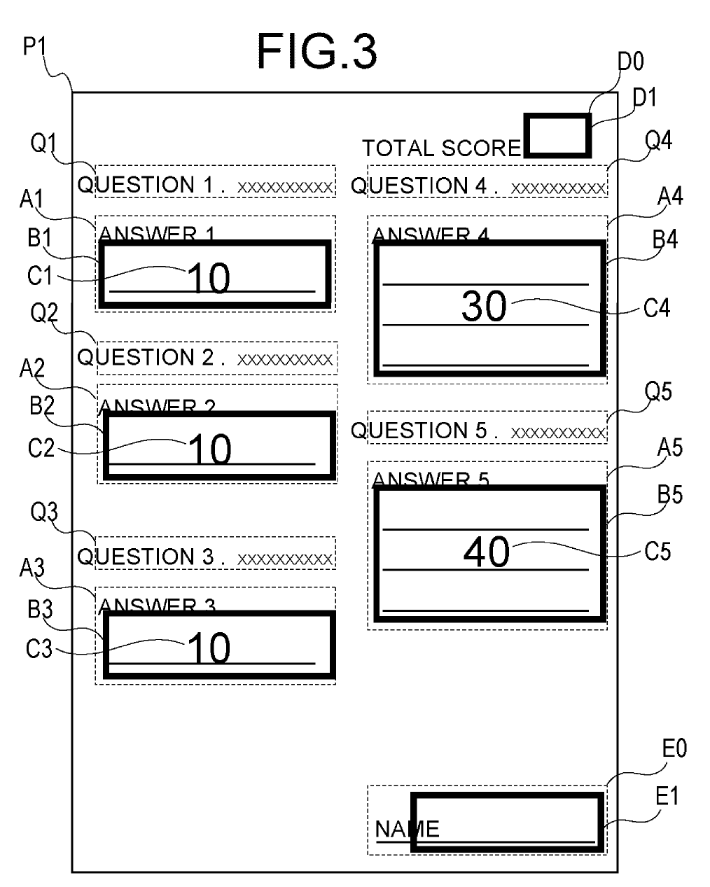

FIG. 3 illustrates an example of a template-scanning-answer sheet P1 that is read by the grading-support-processing unit 60. The template-scanning-answer sheet P1 is marked in the first to fifth answer areas A1 to A5, grading-result field D0 and name-entry area E0. Position information for the first to fifth answer-extraction areas B1 to B5 in which marking is performed for the first to fifth answer areas A1 to A5 is recorded. Here, the position information is a specified location on the sheet, for example, the left corner is expressed as a reference. When the first to fifth answer-extraction areas B1 to B5 are rectangular, the position information is the coordinates of two diagonal points. Similarly, position information for a grading-result-entry area D1, and position information for a name-entry-extraction area E1 in which marking of the name-entry area E0 is performed are recorded.

When the answer sheet P0_01 of an answerer as illustrated in FIG. 2A and FIG. 2B is scanned, the answer fields for each question and the name field for the answerer's name are obtained as image data based on the position information above. Here, for example, the first to fifth answer extraction areas B1 to B5 are marked in red, the grading-result-entry area D1 is marked in blue, and the name-entry-extraction area E1 is marked in green. By changing the color according to the characteristics of the area, or in other words, according to whether the area is an answer field, a name field or the like, it is possible to distinguish in the recognition process after scanning what kind of characteristic a marked area has. Moreover, the results may be displayed on the display-panel unit 41 or the like, and corrections to an area may be received from a user.

Scores C1 to C5 that are set for each respective question are entered inside the first to fifth answer-extraction areas B1 to B5. Here, for example, it can be seen that 10 points are set for the score C2 in the second answer-extraction area B2, and 30 points are set for the score C4 in the fourth answer area A4. The grading-support-processing unit 60, by using an OCR process, extracts the numbers of the scores C1 to C5, correlates those numbers with the respective areas (first to fifth answer-extraction areas B1 to B5), and records the numbers.

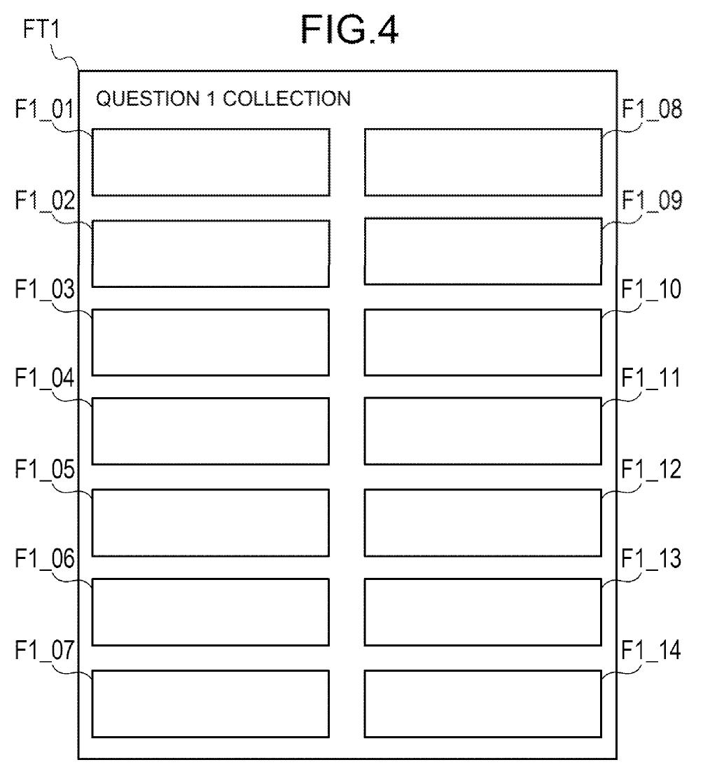

FIG. 4 illustrates an example of a collective-printing template FT1. This kind collective-printing template FT1 is provided for each question, and recorded in the grading-support-processing unit 60. The collective-printing template FT1 illustrated here has a answer area for answer 1 to question 1, or in other words, has a collection area in which a specified number of first answer-extraction areas B1 for the first answer area A1 can be collected and inserted. Here, as the collection areas, first to fourteenth collections areas FT1_01 to FT1_14 are provided as the portions for a maximum of 14 answerers.

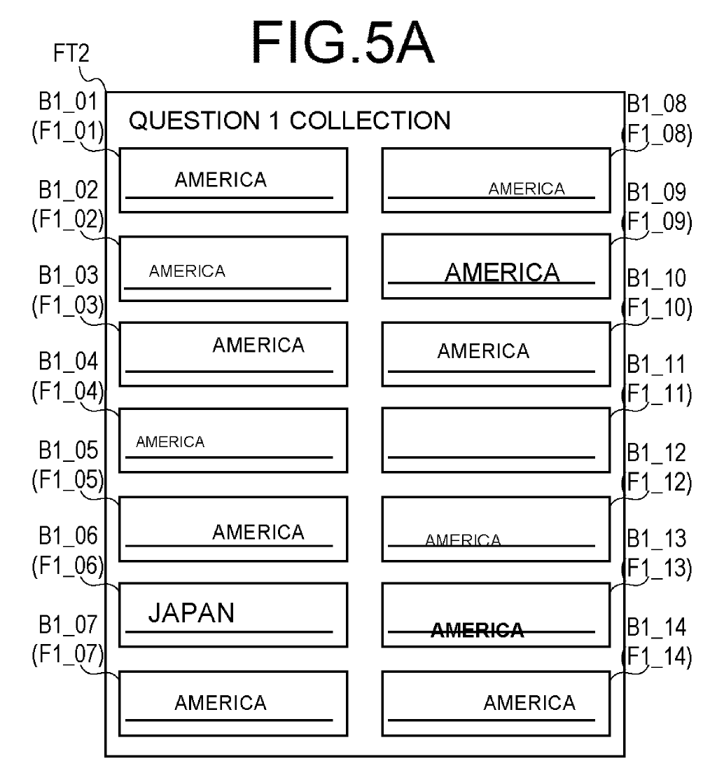

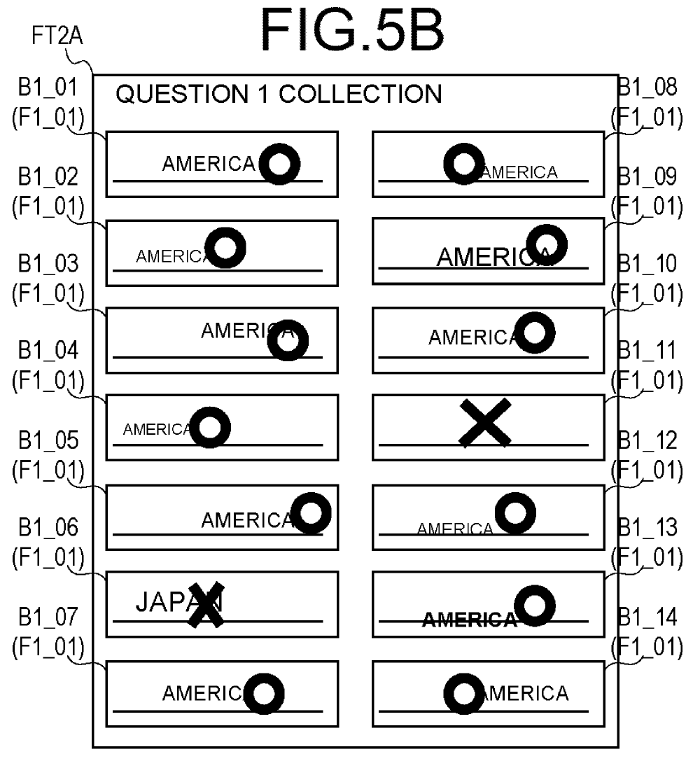

FIG. 5A and FIG. 5B illustrate an example of a collective-printing output for grading (answers), where FIG. 5A illustrates collective-printing output for grading FT2 in the state immediately after output and before grading, and FIG. 5B illustrates collective-printing output for grading FT2A in the state after grading.

As illustrated in FIG. 5A, when performing collective printing for grading, the first answer-extraction areas B1 (first answer-extraction areas B1_01 to B1_14) that is image data for 14 answerers that are scanned and recorded are inserted into the first to fourteenth collection areas FT1_01 to FT1_14, then printed and outputted. Determining which image data of which answerers is to be inserted into which areas may be managed in a specific management table (described later), or indexes that are attached when importing data into a database may be added to the sides of the inserted image data.

As illustrated in FIG. 5B, in the collective-printing output for grading FT2A for which grading is complete, for example, “O” indicating a correct answer is entered by the grader in the first answer extraction areas B1_01 to B1_05, B1_07 to B1_10, and B1_12 to B1_14 in which “America” is entered in the answer fields. Moreover “X” indicating an incorrect answer is entered by the grader in the first answer extraction area B1_06 in which “Japan” is entered in the answer field, and in the first answer extraction area B1_11 in which there is no entry.

The collective printing output for grading FT2A for which grading is completed is scanned, and each first answer extraction area B1_01 to B1_14 is scanned and recorded as image data. Moreover, the grading-support-processing unit 60 performs recognition processing of the grading results using OCR processing, and when there is a “O”, “X” or partial score, identifies that score, then correlates that score with an index such as an ID or the like and records the score. After the collective-printing output for grading has been scanned for all of the questions, the grading results (total scores) are totaled for each respective answerer, and the graded scores that reflect the results are printed and output.

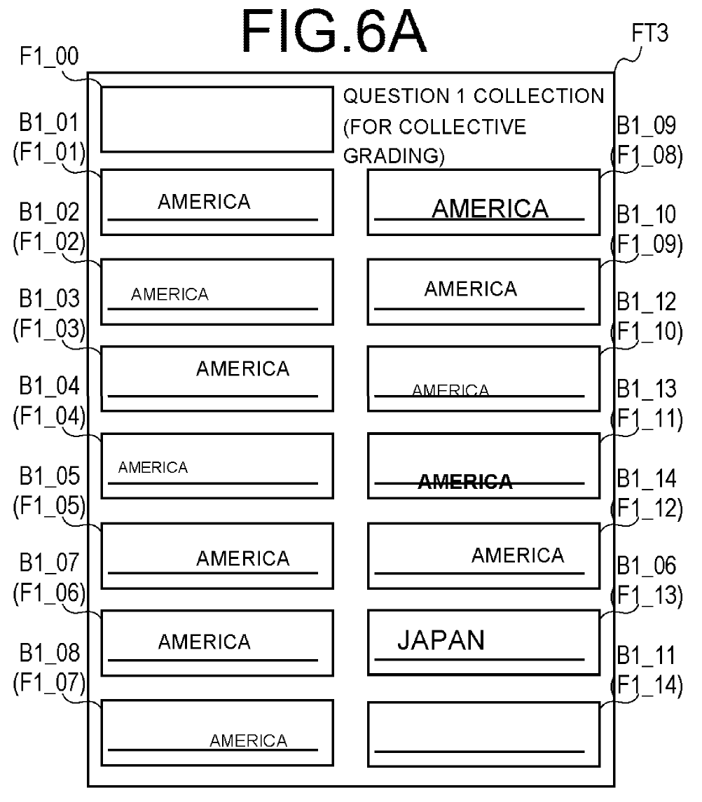

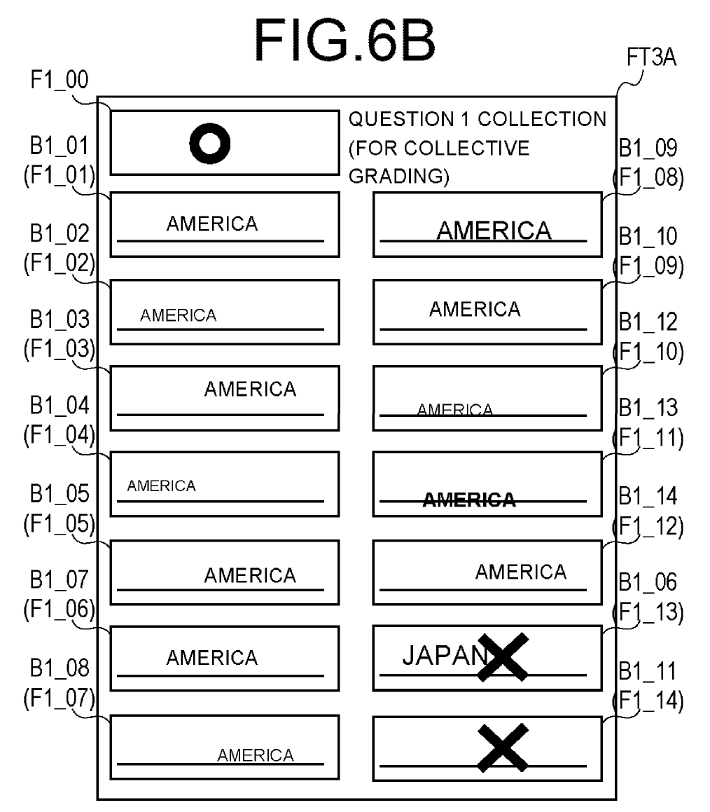

FIG. 6A and FIG. 6B illustrate collective-printing output for grading FT3, FT3A as a variation of that illustrated in FIG. 5A and FIG. 5B, and illustrates examples of collective printing for a collective score (for an auxiliary score). FIG. 6A illustrates collective-printing output FT3 for grading in a state immediately after output before grading, and FIG. 6B illustrates collective-printing output for grading FT3A in a state after grading.

As illustrated in FIG. 6A, the first area of the page is provided with a blank area that is a collective-grade space F1_00. The collective-grade space F1_00 has the same shape as the other answer fields. Moreover, when the answer fields (first answer-extraction area B1_01 to B1_14) are inserted, specified sorting is performed. Here, sorting is performed based on numbers of characters, and image data in which “America” is entered in the answer field is on top, followed by image data in which “Japan” is entered, and image data in which there is no entry is arranged last. In other words, by performing sorting, the correct answers are arranged in one group so grading is simplified.

In FIG. 6B, the grader enters a “O” or “X” in the collective-grade space F1_00. Here, “O” is entered in the collective-grade space F1_00. For example, when the grader enters “O” in the collective-grade space F1_00, when performing actual grading, “X” is entered into the answer fields of incorrect answers, however “O” is not entered in the answer fields of correct answers. In other words, when “O” is entered in the collective-grade space F1_00, entry of a score is omitted.

When the grading-support-processing unit 60 scans the collective-printing-output for grading FT3A after grading, for the answer fields in which “X” is not entered, in other words, for the answer fields in which “O” is omitted the image data of the collective-grade space F1_00 and the image data of the answer fields are combined. Then, each first answer-extraction area B1_01 to B1_14 is extracted and recorded as image data. The timing for combining the image data may also be before or after extracting each first answer-extraction area B1_01 to B1_14.

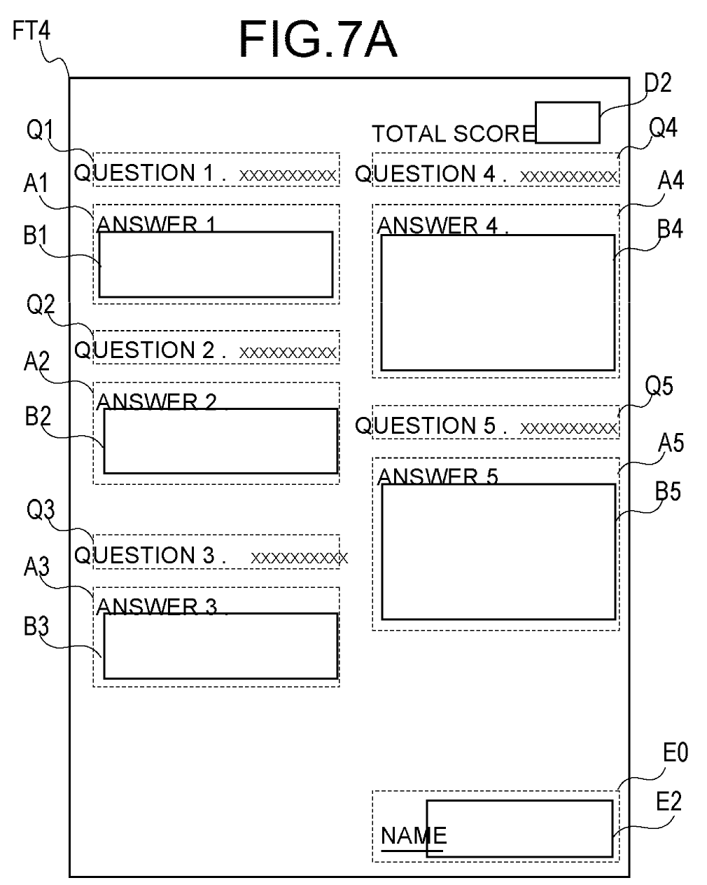

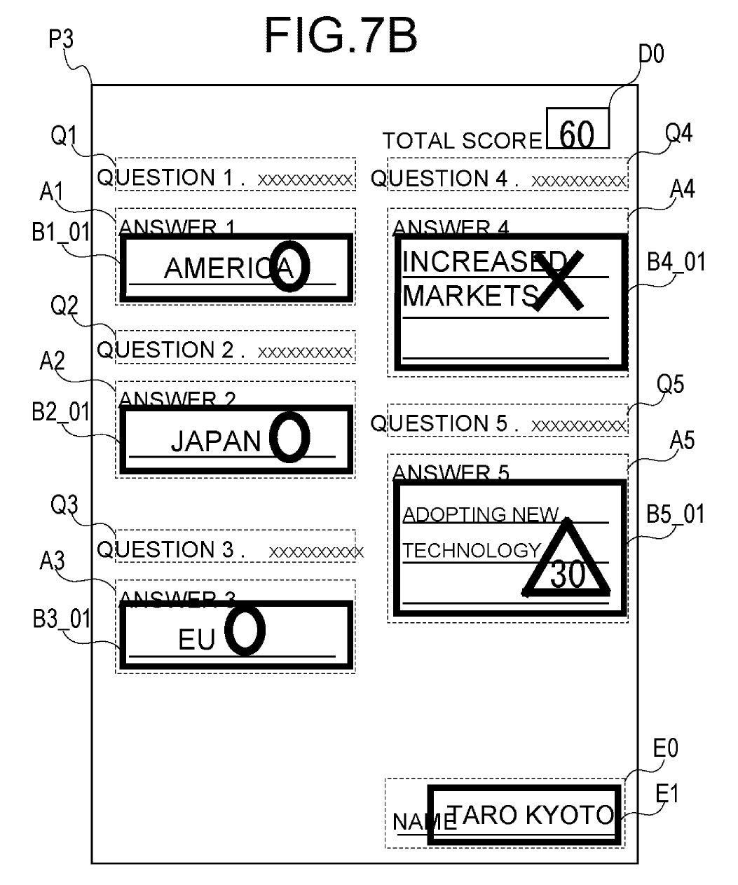

FIG. 7A and FIG. 7B are examples of a post-grading printing template FT4 and the final output result P3 that reflects the grading result on that template. The post-grading printing template FT4 that is illustrated in FIG. 7A is used when attaching image data of answer fields after grading when performing printing output after grading for each answerer. This post-grading printing template FT4 is formed at the same timing when the marked template-scanning answer sheet P1 described above is scanned. In other words, image data that excludes the marked first to fifth answer-extraction areas B1 to B5 and the name-entry-extraction area E1 from the template scanning answer sheet P1 is recorded as the post-grading printing template FT4.

Moreover, as illustrated in FIG. 7B in the final output result P3, during the post-grading output process the image data of each answer area after grading and the image data for the name are inserted into the post-grading printing template FT4, and furthermore the grading result (total score) is written and this is outputted as the final output result. The final output result P3 illustrated here is the state in which “O”, “X”, partial score and the total score are added to the scanned answered answer sheet P0_01 that is illustrated in FIG. 3.

Next, the detailed configuration of the grading-support-processing unit 60 and the detailed processing of achieving each of the processes described above will be explained.

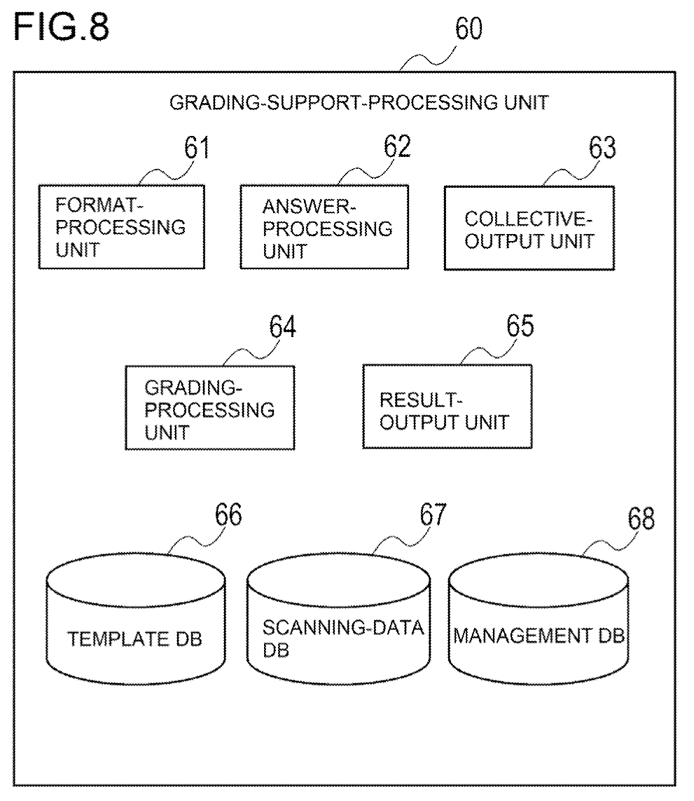

FIG. 8 is a function block diagram of the grading-support-processing unit 60. The grading-support-processing unit 60 includes a format-processing unit 61, an answer-processing unit 62, a collective-output unit 63, a grading-processing unit 64, a result-output unit 65, a template DB 66, a scanning-data DB 67 and a management DB 68.

Here, the function of the format-processing unit 61, the answer-processing unit 62, the collective-output unit 63 and the grading-processing unit 64 may be achieved by a dedicated MPU or the like, or may be achieved by a control unit 20. The template DB 66, scanning-data DB 67 and answerer-management DB 68 may be a specially provided storage area, or part of the storage unit 50 may be used.

The format-processing unit 61 creates formats (templates) that are used in the grading-support process. Here, the format-processing unit 61 creates the collective-printing template FT1 illustrated in FIG. 4, and the post-grading printing template FT4 illustrated in FIG. 7A and FIG. 7B.

More specifically, the format-processing unit 61 reads a sheet on which marking has been performed on an unused answer sheet (template-scanning-answer sheet P1) by the scanning-execution-processing unit 32. Then, identifies the position information for all of the answer areas (first to fifth answer-extraction areas B1 to B5), name-entry-extraction area E1, and grading-result-entry area D1, and stores that information in the template DB 66. All of the answer areas means all of the answer areas for 5 questions when there are 5 questions.

Moreover, as explained in FIG. 7A and FIG. 7B, the output process of attaching all of the answer areas to the user's answer sheet is performed after grading, however, the format-processing unit 61 creates a post-grading printing template FT4 that will be the base sheet at that time and records that template in the template DB 66.

The answer-processing unit 62 uses the scanning-execution-processing unit 32 to scan an answer sheet P0_01 that is answered by a user, and extracts the first to fifth answer-extraction areas B1 to B5 and the name-entry-extraction area E1 as image data. Then, correlates these, or in other words, records the image data together with an index (ID or the like) that indicates to which user the data belongs in the scanning-data DB 67.

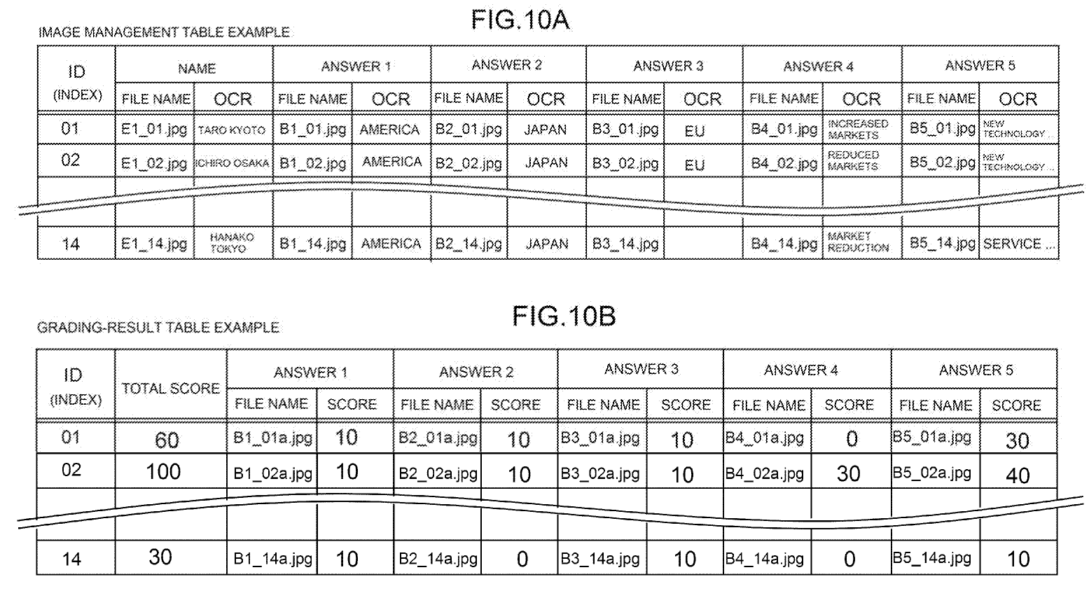

For example, when there are 14 answerers, 14 answer sheets are scanned, and the image data is recorded. The answer-processing unit 62 performs OCR processing of the extracted answer areas, extracts character information, and correlates and records an index and the extracted image data. The correlated information is recorded in the management DB 68 as a specified management table. Details of the management table will be described later using FIG. 10A and FIG. 10B.

The collective-output unit 63 obtains the answer areas (image data) for all of the users for each question from the scanning-data DB 67 (pre-grading data unit 70 that will be described later), and collects that data in the collective-printing template FT1, then prints and outputs the collective-printing template FT1. For example, when there are 14 answerers, answer data for 14 people for the same question is collected. The grader grades the printed out collective-printing sheet.

The data may also be outputted as digital data without printing out the data, and the grading work may be performed using a tablet terminal or the like. Moreover, in the collection process, the collection order can be sorted as desired based on the OCR process by the answer-processing unit 62. For example, there is the order of largest number of character information (in other words, the number of characters) extracted in the OCR process, or there is the order of whether or not specified wording is included. Furthermore, the sorting criteria are used when performing correlation with an ID when extracting image data by scanning the collective-printing output for grading FT2A after grading.

When outputting the collective printing output for grading FT2, information about the sorting criteria may be included. When scanning the collective-printing output for grading FT2A after grading is completed, it is possible to obtain that information about the sorting criteria, and use it when performing correlation with the ID. The outputted collective-printing output for grading FT2 is a group of answers for the same question, so correct answers are printed in a continuous group.

The grading-processing unit 64 uses the scanning-execution-processing unit 32 and scans the collective-printing output for grading FT2A in the state after grading such as illustrated in FIG. 5B. Furthermore, the grading processing unit 64 extracts each answer area after grading (first answer-extraction areas B1_01 to B1_14 in FIG. 5B), then performs correlation with the ID and saves the results in the scanning-data DB 67 (more specifically, the post-grading data unit 80 described later).

Moreover, the grading-processing unit 64 performs OCR processing of the extracted answer areas, and extracts grade results. More specifically, the grading-processing unit 64 extracts a “O”, “X” or partial score (reduced points) that is added by a grader from the difference between the pre-grading image data and the post-grading image data, and obtains the added portion as character information, then further correlates and records the ID and image data. When collective printing for collective grading illustrated in FIG. 6A and FIG. 6B is used and there is a “O” or “X” in the collective-grade space F1_00, grades that do not have a check in the grading results in an individual answer field reflects a grade as if the grade of this collective grade were given. In other words, image data is updated after combining the mark in the collective-grade space F1_00 with the image data of the answer.

The result-output unit 65 obtains the image data of the post-grading answer area and name, and the total score from the recorded data in the scanning-data DB 67 and management DB 68 for each answerer, reflects these on the post-grading printing template FT4, and creates and outputs the final output results P3 such as illustrated in FIG. 7B.

The template DB 66 records collective-printing templates FT1 and post-grading printing templates FT4 that are created by the format-processing unit 61. Moreover, the template DB 66 records position information for each of the first to fifth answer-extraction areas B1 to B5, the grading-result-entry area D1, and the name-entry-extraction area E1, and the score that is set for each question.

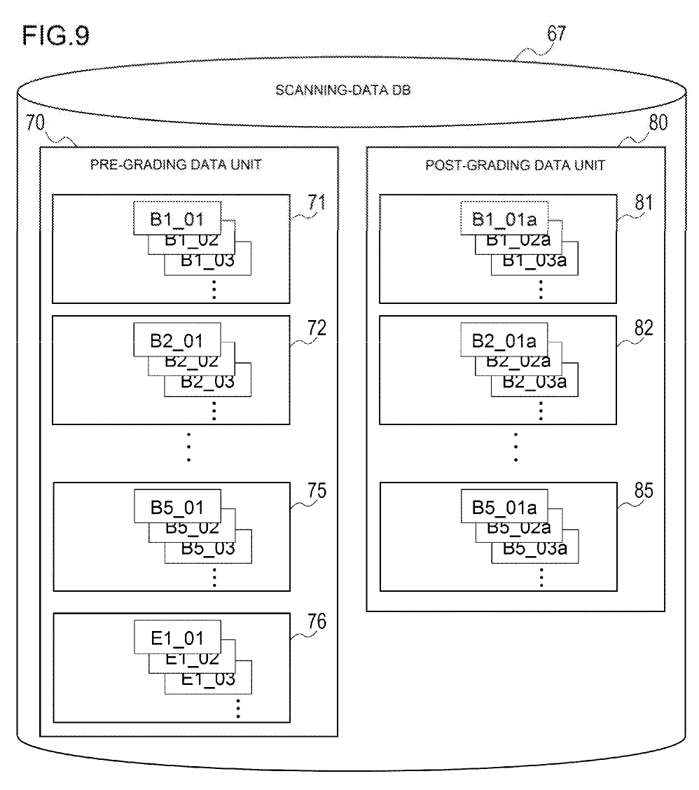

FIG. 9 is a function block diagram illustrating the configuration of the scanning-data DB 67. The scanning-data DB 67 includes pre-grading-data unit 70 that records extraction data for an answer sheet before grading, and a post-grading-data unit 80 that records extraction data of a collective sheet after grading.

As illustrated in FIG. 9, the pre-grading-data unit 70 of the scanning-data DB 67 includes a first answer-data unit 71 to fifth answer-data unit 75, and a name-data unit 76.

The first answer-data unit 71 records the first answer-extraction areas B1 of the scanning results of the answer sheets answered by the users as image data having a specified format (for example, a JPEG format image). Similarly, the second answer-data unit 72 to fifth answer-data unit 75 record the second answer-extraction areas B2 to fifth answer-extraction areas B5 of the scanning results of the answer sheets answered by the users as image data having a specified format. The name-data unit 76 records the name-entry-extraction areas E1 of the scanning results of the answer sheets answered by the users as image data. After scanning all of the answered answer sheets, databases (first answer-data unit 71 to fifth answer-data unit 75) for only the extracted image data of the respective answers are created.

The post-grading-data unit 80 includes a first answer-data unit 81 to fifth answer-data unit 85. The first answer-data unit 81 records post-grading scanning data of a collective-printing sheet for answer 1 as image data having a specified format extracted in an area for each answerer. The second answer-data unit 82 to fifth answer-data unit 85 similarly record respective post-grading scanning data of a collective-printing sheet for answer 2 to answer 5 as image data extracted in an area for each answerer.

The explanation will return to the explanation of FIG. 8. The management DB 68 holds specified tables that manage the scanned answer sheets, the scanned post grading collective-printing output for grading FT2A, FT3A, and the grading results. Here, there is an image-management table for managing scanned image data and a grading-results table for collecting and managing the grading results.

FIG. 10A and FIG. 10B illustrate examples of the tables provided in the management DB 68. More specifically, FIG. 10A illustrates an example of an image-management table, and FIG. 10B illustrates an example of a grading-results table. The image-management table and the grading-results table may also be provided as one table.

The image-management table is used as a table for managing scanning results of the answer sheets P0_01 by the answer-processing unit 62. More specifically, IDs that are respectively assigned to the scanned answer sheets P0-01, the file names and OCR results of the image data of the name-entry-extraction areas E1, the file names and OCR results of the image data of the first to fifth answer-extraction areas B1 to B5 are correlated and recorded. For example, as illustrated in FIG. 10A, for the name of the answerer having ID “02”, the image data is “E1_02.jpg”, and the OCR processing result is “Ichiro Osaka”. Moreover, the image data for the answer to the first question (first answer-extraction area B1) is “B1_02.jpg”, and the OCR processing result is “America”.

The grading-results table is used as a table for managing the scanning result of the post-grading collective-printing output for grading FT2A by the scanning-execution-processing unit 32. More specifically, IDs, total scores, file names of the image data and grading results of the of the post-grading first to fifth answer-extraction areas B1 to B5 are correlated and recorded. More specifically, for example, the post-grading image data of the answer to question 1 (first answer-extraction area B1) of the answerer having the ID “02” is “B1_01a.jpg”, and the score is “10” points. Moreover, the total of each of the scores for the post-grading first to fifth answer-extraction areas B1 to B5 is “100” points.

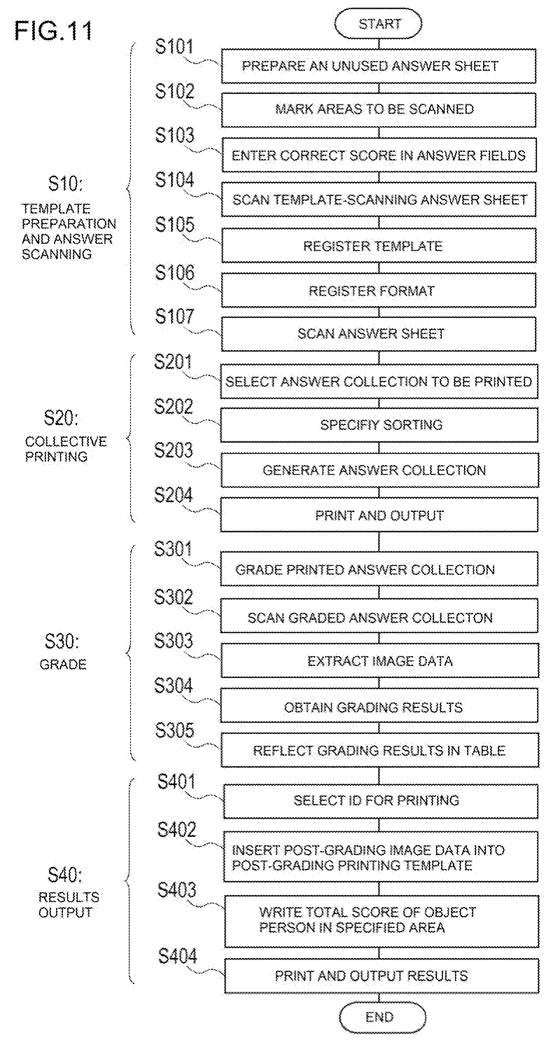

FIG. 11 is a flowchart of the grading-support process. The flow of the grading-support process is explained with reference to this flowchart.

The grading-support process is roughly divided into a template-preparation and answer-scanning process (S10), a collective-printing process (S20), a grading process (S30), and a results-output process (S40) that are performed in that order. Each process is selected, for example, from a specified menu screen.

In the template-preparation and answer-scanning process (S10), a grader or the like that is using this function prepares an unused answer sheet P0 (S101), marks the areas corresponding to scanning (S102), and enters scores in the answer fields (S103). As a result of doing this, preparation of a template-scanning answer sheet P1 such as illustrated in FIG. 3 is completed. Next, the grader or the like scans the template-scanning answer sheet P1 that is marked or the like (S104), and performs a template registration process (S105). In other words, the format-processing unit 61 identifies the position information and scoring of the areas marked from the scanned template-scanning answer sheet P1, and records the result in the template DB 66.

Next, the format-processing unit 61 executes a format-registration process using the scanned template-scanning answer sheet P1 (S106). In other words, creates the collective-printing template FT1 in FIG. 4, and the post-grading printing template FT4 in FIG. 7A, and records the templates in the template DB 66.

After preparation of the format and the like is complete, scanning of the answered answer sheets P0_01 illustrated in FIG. 2 is performed for all of the answerers (S107). The answer-processing unit 62 extracts the first to fifth answer-extraction areas B1 to B5, and the name-entry extractions areas E1 as image data, then correlates and records the image data in the scanning-data DB 66 (in the pre-grading data unit 70).

Continuing, the collective-printing process (S20) will be explained. The collective-output unit 63 receives a selection from the grader or the like for an answer collection that is the object of collective printing (S201). At this time, a sorting specification is also received (S202).

After the specifications above are completed, the collective-output unit 63 generates an answer collection (collective-printing output FT2 for grading such as in FIG. 5A) that is collected from answers that are extracted from only the same answer field according to the collective-printing template FT1 of answers that is created beforehand (S203), and prints and outputs that answer group (S204).

In the grading process (S30), first, the grader performs grading of the printed answer collection (collective-printing output for grading FT2), and obtains a graded answer collection (collective printing output for grading FT2A) such as illustrated in FIG. 5B (S301). Next, the grading-processing unit 64 scans the graded collective-printing output for grading FT2A (S302).

The grading-processing unit 64 extracts the post-grading answer-extraction areas from the scanned collective-printing output for grading FT2A as image data, and after correlation with the IDs, records the image data in the post-grading data unit 80 (S303). Furthermore, the grading-processing unit 64 obtains the grading results by identifying “Os”, “Xs” and the like that are added to image data (S304), then correlates the grading results with IDs and the like, and reflects the results in a grading-results table (S305).

After all scanning is complete, the result-output process for printing the graded answer sheets is performed based on the post-grading printing template (S40). The result-output unit 65 receives a specification of the ID of a person for printing from a user such as a grader or the like (S401). The ID specification may be for a single ID, or may be for plural IDs.

The result-output unit 65 extracts the image data of the answerer having an ID for which a specification was received (person who is the object of printing) from the post-grading data unit 80 (first answer-data unit 81 to fifth answer-data unit 85), and extracts the image data of the name from the name-data unit 76, then inserts that image data into the post-grading printing template FT4 (S402). Furthermore, the result-output unit 65 references the grading-results table of the management DB 68, and writes the total score of the object person in a specified area (grading-result-entry area D1) (S403), and prints and outputs the result as illustrated in FIG. 7A and FIG. 7B (S404). When there are plural specified IDs, printing and output is performed for all of the IDs.

With the embodiment described above, grading can be performed using a sheet on which only answers for the same question are arranged, so grading is simplified. Moreover, using OCR, similar answers are printed consecutively, and grading is performed in a state in which the grader does not know who the answerer is, so it becomes easy to perform grading based on consistent criteria for the same answer. Moreover, when a collective grading field is used, there is no need to perform grading individually for each of the same answers, so it is possible to reduce the number of grading steps. Furthermore, a database of the grading results is created at the same time, so managing results is also simplified.

An embodiment according to the present disclosure was explained above. This embodiment is only an example, and it is understood by one skilled in the art that various modifications by combining these components is possible, and that those modifications are also within the range of the present disclosure.

In typical technology, when performing grading of answer sheets of questions such as a test, it is necessary to recheck a created sheet that has been checked with “Os” and “Xs”, and manually calculate the total score based on the checked “Os” and “Xs”, so different technology was desired. Moreover, unless “Os” and “Xs” are checked for each individual answer on a collectively printed sheet, there is a problem that the results are not reflected when replacing with the original answer sheet.

According to the present disclosure, it is possible to achieve technology that is capable of effectively supporting grading of answer sheets.

What is claimed is:

1. An image forming apparatus comprising:
an answer-processing unit that obtains an answer sheet on which answers are written as image data, identifies areas of answer fields on the answer sheet, extracts image data of the answer fields, and holds the image data in a specified storage area;
a collective-output unit that collects and arranges image data of plural answerers that is held in the storage area for an answer field for a same question, and generates and outputs printing data for grading;
a grading-processing unit that obtains the printing data for grading that has been graded as image data and holds that image data in a specified storage area, extracts information that is added to the graded printing data for grading, and based on the extracted information determines a score for the answer field, and for each answerer, calculates a total score of the scores of the answer fields of all questions included on the answer sheet; and
a result-output unit that collects the graded answer fields for all of the questions and the total score for each answerer, and outputs the answer sheets that were answered by the answerers in a graded state.

2. The image forming apparatus according to claim 1, comprising
an answer-sheet-information-obtaining unit that obtains information for identifying areas of the answer fields on the answer sheet, and scoring information that is set for the answer fields; wherein
the answer-processing unit, based on the information that is obtained by the answer-sheet-information-obtaining unit, identifies areas of the answer fields.

3. The image forming apparatus according to claim 1, wherein
the collective-output unit, when generating printing data for grading, includes a collective-grading area; and
the grading-processing unit, in the graded printing data for grading, combines a mark that is added to the collective-grading area to an answer area to which a mark is not added, and regards that as the image data for the graded answer field.

4. The image forming apparatus according to claim 1, wherein
the collective-output unit, when generating printing data for grading, determines the arrangement order when collecting image data of answer fields based on character information that is included in the answer fields.

5. A grading-assistance method that is a grading-assistance method that uses an image forming apparatus, and comprising:
an answer-processing step of obtaining an answer sheet on which answers are written as image data, identifying areas of answer fields on the answer sheet, extracting the image data of the answer fields, and holding the image data in a specified storage area;
a collective-output step of collecting and arranging image data of plural answerers that is held in the storage area for answer fields for the same question, and generating and outputting printing data for grading;
a grading-processing step of obtaining graded printing data for grading as image data, holding that image data in a specified storage area, extracting information that is added to the graded printing data for grading, and based on the extracted information determining a score for the answer fields, and for each answerer, calculating a total score of the scores of the answer fields of all questions included on the answer sheet; and
a result-output step of collecting the graded answer fields for all of the questions and the total score for each answerer, and outputting the answer sheets that were answered by the answerers in a graded state.

6. The grading-assistance method according to claim 5, comprising
an answer-sheet-information-obtaining step of obtaining information for identifying areas of the answer fields on the answer sheet, and scoring information that is set for the answer fields; wherein
the answer-processing step, based on the information that is obtained by the answer-sheet-information-obtaining unit, identifies areas of the answer fields.

7. The grading-assistance method according to claim 5, wherein
the collective-output step, when generating printing data for grading, includes an assisted-grading area; and
the grading-processing step, in the graded printing data for grading, combines a mark that is added to the assisted-grading area to an answer area to which a mark is not added, and regards that as the image data for the graded answer field.

8. The grading-assistance method according to claim 5, wherein
the collective-output step, when generating printing data for grading, determines the arrangement order when collecting image data of answer fields based on character information that is included in the answer fields.
